(19) United States
(12) Patent Application Publication
(10) Pub. No.: US 2026/0239509 A1
(43) Pub. Date: Aug. 13, 2026

(54) HIGH-POWER-DENSITY DIMMING POWER SUPPLY AND CONTROL METHOD THEREOF

(71) Applicant: Zhuhai Shengchang Electronics Co., Ltd., Zhuhai City (CN)

(72) Inventors: Xianyun ZHAO, Zhuhai City (CN); Dehua ZHENG, Zhuhai City (CN)

(21) Appl. No.: 19/171,167

(22) Filed: Apr. 4, 2025

(30) Foreign Application Priority Data
Feb. 13, 2025 (CN) 2025101601333

(51) Int. Cl. H05B 47/10; H02M 1/42

(52) U.S. Cl. CPC H05B 47/10; H02M 1/4208

(57) ABSTRACT

Disclosed is a high-power-density dimming power supply and a control method thereof, and relates to the technical field of dimming power supplies. The dimming power supply includes an outer housing and a control circuit board disposed in the outer housing, and a control circuit is disposed on the control circuit board. The control circuit includes a rectification filtering circuit, a power factor correction circuit, a DC-DC power conversion circuit, an output control circuit and a main control circuit. The DC-DC power conversion circuit uses a soft switching circuit architecture, and has a working frequency above 110 KHz. The control circuit board includes a main board and a plurality of sub boards vertically disposed on the main board. In a case that the power factor correction circuit is in a continuous conduction mode, a working frequency of the power factor correction circuit is above 75 KHz.

### TECHNICAL FIELD

The present disclosure relates to the technical field of dimming power supplies, and in particular to a high-power-density dimming power supply and a control method thereof.

### BACKGROUND

With the improvement of people’s living standards, the requirements on lamplight are also increasing, and the lamplight needs to be adjusted in some life scenes. For most lamplight adjusting manners, a dimming instruction is sent to a dimming power supply by a dimmer or a dimming system, the dimming power supply adjusts to change output after receiving a dimming signal, so that the brightness, color temperature or color of the lamplight is changed. In such manners, the wiring is troublesome, the dimmer or the dimming system is needed, and at the same time, the matched dimming power supply in a corresponding dimming manner is needed. For example, if the dimmer is a 0-10 V dimmer, the matched dimming power supply shall be a 0-10 V dimming power supply. In order to solve the above technical problems, some manufacturers have developed some products with a power supply and a dimmer combined to be placed into a housing in a size of a dimming switch, but these products generally utilize the conventional technology and use silicon metal oxide semiconductor (MOS) transistors, the working frequency is generally set to be a value about 40 KHz to 70 KHz, and the power is low, and generally does not exceed 100 W, so they may not meet the requirements in higher-power application.

### SUMMARY

In order to overcome the defects in the prior art, the objective of the present disclosure is to provide a high-power-density dimming power supply capable of increasing the power density of the dimming power supply, so that the output power of the power supply may be increased without product size increase, and the requirement of high-power application may be met.

In order to solve the above problems, the present disclosure adopts the following technical solution: a high-power-density dimming power supply includes an outer housing and a control circuit board, the outer housing includes a control panel and a rear housing, the control circuit board is disposed in a space defined by the control panel and the rear housing, a control device is disposed on the control panel, a control circuit is disposed on the control circuit board, an input terminal and an output terminal are disposed on the rear housing, the control circuit includes a rectification filtering circuit, a power factor correction circuit, a direct current (DC)-DC power conversion circuit, an output control circuit and a main control circuit, an input end of the rectification filtering circuit is electrically connected with commercial power through the input terminal, an output end of the rectification filtering circuit is electrically connected with an input end of the power factor correction circuit, an output end of the power factor correction circuit is electrically connected with an input end of the DC-DC power conversion circuit, an output end of the DC-DC power conversion circuit is electrically connected with an input end of the output control circuit, the DC-DC power conversion circuit supplies electricity to the main control circuit, an output end of the output control circuit is electrically connected with a lamp load through the output terminal, the output control circuit is controlled by the main control circuit, the control device is electrically connected with the main control circuit, the DC-DC power conversion circuit uses a soft switching circuit architecture, a working frequency of the DC-DC power conversion circuit is set to be a value above 110 KHz, the control circuit board includes a main board and a plurality of sub boards vertically disposed on the main board, electronic components in the control circuit are distributed on the main board and the sub boards, and in a case that the power factor correction circuit is in a continuous conduction mode, a working frequency of the power factor correction circuit is above 75 KHz; or in a case that the power factor correction circuit is in a critical conduction mode, the working frequency near a zero crossing point is not limited, and in a case that a voltage is above 1/2 of a wave peak voltage of alternating current, the working frequency of the power factor correction circuit is set to be a value above 75 KHz.

Compared with the prior art, the present disclosure has the beneficial effects that by increasing the working frequencies of the DC-DC power conversion circuit and the power factor correction circuit, the sizes of magnetic elements in the DC-DC power conversion circuit and the power factor correction circuit are reduced, the power density of the power supply is increased, and the output power of the power supply is improved. At the same time, the dimming power supply uses a three-dimensional control circuit board combination formed by combining the sub boards and the main boards, and a space inside the outer housing is sufficiently utilized, so that the power density of the dimming power supply is further increased. The dimming power supply may realize output power improvement of the product without product size increase, so as to adapt a high-power application scenario.

According to the high-power-density dimming power supply, a plurality of slots or welding through holes are formed in the main board, one end of each of the sub boards is provided with a conductive contact plate matched with the corresponding slot or a welding bonding pad matched with the corresponding welding through hole, and the sub boards are electrically connected with the main board through inserting the conductive contact plates into the slots or through welding.

According to the high-power-density dimming power supply, an MOS transistor in the power factor correction circuit is a 3^{rd} generation semiconductor gallium nitride MOS transistor.

According to the high-power-density dimming power supply, an MOS transistor in the DC-DC power conversion circuit is a 3^{rd} generation semiconductor gallium nitride MOS transistor.

According to the high-power-density dimming power supply, each of a boost inductor in the power factor correction circuit and a coil of a transformer in the DC-DC power conversion circuit is formed by winding a stranded wire with a diameter of 0.1 mm or below.

According to the high-power-density dimming power supply, the rectification filtering circuit is an active bridge rectification circuit.

According to the high-power-density dimming power supply, the control device includes a switch and a dimming control device.

A control method of the high-power-density dimming power supply includes: controlling the working frequency of the DC-DC power conversion circuit to be above 110 KHz, and in a case that the power factor correction circuit works in a continuous conduction mode, controlling the working frequency of the power factor correction circuit to be above 75 KHz; and in a case that the power factor correction circuit works in a critical conduction mode, skipping limiting the lowest working frequency near a zero crossing point, and in a case that a voltage is above 1/2 of a wave peak voltage of alternating current, controlling the working frequency of the power factor correction circuit to be above 75 KHz.

The present disclosure will be further illustrated in detail in combination with the accompanying drawing and the specific implementations.

### BRIEF DESCRIPTION OF THE DRAWINGS

FIG. 1 is a schematic structure diagram of a high-power-density dimming power supply according to an embodiment of the present disclosure;

FIG. 2 is a schematic structure diagram of a control circuit board according to an embodiment of the present disclosure;

FIG. 3 is a principle block diagram of a control circuit according to an embodiment of the present disclosure.

In the figures,

100 denotes an outer housing, 110 denotes a control panel, 111 denotes a switch, 112 denotes a draw runner, 120 denotes a rear housing, 200 denotes a control circuit board, 210 denotes a main board, and 220 denotes a sub board.

### DETAILED DESCRIPTION OF THE EMBODIMENTS

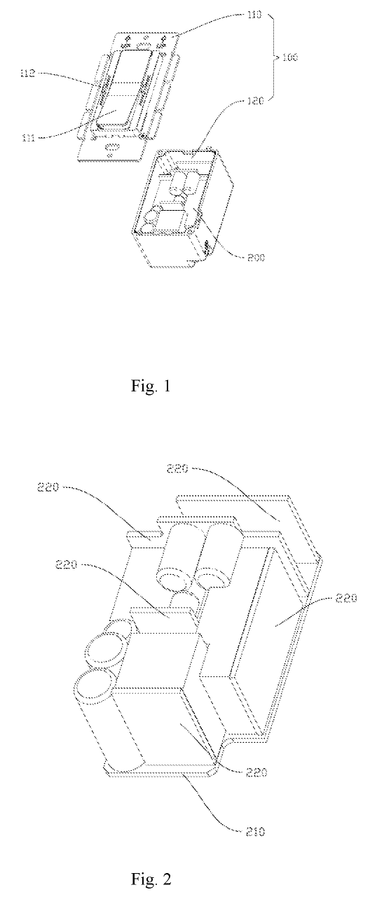

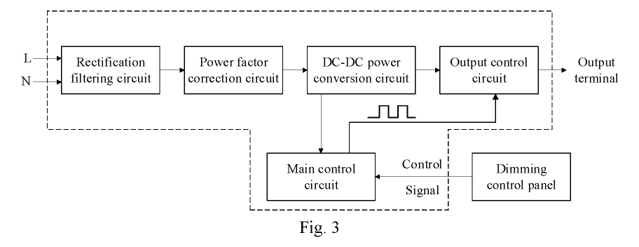

Embodiments of the present disclosure will be described in detail hereafter. Referring to FIG. 1 to FIG. 3, an embodiment of the present disclosure provides a high-power-density dimming power supply, including an outer housing 100 and a control circuit board 200. The outer housing 100 includes a control panel 110 and a rear housing 120, the control circuit board 200 is disposed in a space defined by the control panel 110 and the rear housing 120, a control device is disposed on the control panel 110, a control circuit is disposed on the control circuit board 200, and an input terminal and an output terminal are disposed on the rear housing 120. The control circuit includes a rectification filtering circuit, a power factor correction circuit, a DC-DC power conversion circuit, an output control circuit and a main control circuit. An input end of the rectification filtering circuit is electrically connected with commercial power through the input terminal, an output end of the rectification filtering circuit is electrically connected with an input end of the power factor correction circuit, and the rectification filtering circuit is used for eliminating electromagnetic interference from the input commercial power and rectifying alternating current into pulsating direct current and then inputting the pulsating direct current into the power factor correction circuit. An output end of the power factor correction circuit is electrically connected with an input end of the DC-DC power conversion circuit, and the power factor correction circuit is used for reducing current harmonics to bring stable direct current power supply to the DC-DC power conversion circuit. An output end of the DC-DC power conversion circuit is electrically connected with the output control circuit, and the DC-DC power conversion circuit is used for boosting or bucking the input stable direct current to generate the stable direct current with a required voltage value and supply electricity to the output control circuit and the main control circuit. The output control circuit is controlled by the main control circuit. An output end of the output control circuit is electrically connected with a lamp load through the output terminal, the control device is electrically connected with the main control circuit, the output control circuit controls the power output to the lamp load under the control of the main control circuit according to a dimming signal of the control device or an external dimming signal, so that a lamp gives out required light. The DC-DC power conversion circuit uses a soft switching circuit architecture, and a working frequency of the DC-DC power conversion circuit is set to be a value above 110 KHz. The control circuit board 200 includes a plurality of sub boards 220 vertically disposed on a main board 210, and electronic components in the control circuit are distributed on the main board 210 and the sub boards 220. In a case that the power factor correction circuit is in a continuous conduction mode, a working frequency of the power factor correction circuit is above 75 KHz; or in a case that the power factor correction circuit is controlled to be in a critical conduction mode, the working frequency near a zero crossing point is not limited, and in a case that a voltage is above 1/2 of a wave peak voltage of alternating current, the working frequency of the power factor correction circuit is set to be a value above 75 KHz.

The high-power density dimming power supply reduces the sizes of magnetic elements in the DC-DC power conversion circuit and the power factor correction circuit by improving the working frequencies of the DC-DC power conversion circuit and the power factor correction circuit, so that the sizes of the DC-DC power conversion circuit and the power factor correction circuit are reduced, and the power density of the whole dimming power supply is increased. The DC-DC power conversion circuit uses a soft switching circuit architecture to further reduce the loss. The control circuit board 200 uses a three-dimensional circuit board structure consisting of a main board 210 and sub boards 220. A space inside the outer housing 100 may be sufficiently utilized, so that the power density of the dimming power supply is further increased. The high-powder-density dimming power supply may improve the output power of the power supply to a value above 100 W without increasing the product size, and in some application scenarios, the output power of the power supply may even reach a value above 200 W to adapt to high-power application scenarios.

It could be understood that in some embodiments, the MOS transistors used in the power factor correction circuit and the DC-DC power conversion circuit are 3^{rd} generation semiconductor gallium nitride MOS transistors, and it is favorable for reducing the switch loss of the circuit and further reducing the size and heat generation of the product, so that the power density of the product is further increased. The rectification filtering circuit is suitable for adopting an active bridge rectification circuit to further reduce the loss and the heat dissipation, improve the rectification efficiency, and further increase the power density of the product. The DC-DC power conversion circuit may use a soft switching circuit architecture such as inductor-inductor-capacitor (LLC), active half bridge (AHB) or active clamp flyback (ACF), each of a boost inductor in the power factor correction circuit and a coil of a transformer in the DC-DC power conversion circuit is formed by winding a stranded wire with a diameter of 0.1 mm or below, so as to reduce the skin effect, further reduce the loss, and increase the power density.

In some embodiments, in order to conveniently connect the sub boards 220 and the main board 210, a plurality of slots are formed in the main board 210, one end of each of the sub boards 220 is provided with a conductive contact plate matched with the corresponding slot of the main board 210, and the sub boards 220 are electrically connected with the main board 210 through inserting the conductive contact plates into the corresponding slots. In some embodiments, the sub boards 220 and the main board 210 may also be connected through welding. A plurality of welding through holes are formed in the main board 210, and one end of each of the sub boards 220 is provided with a welding bonding pad matched with the corresponding welding through hole. It could be understood that in some embodiments, the output terminals may be configured to be more than two paths to meet the requirements of the USA specification CLASS2 standard, or to realize the color temperature and brightness adjustment.

It could be understood that the main control circuit generally controls the output control circuit through a pulse-width modulation (PWM) signal, and the control device includes a switch 111 and a dimming controller. The dimming controller may use components such as draw runners 112, a push rod, a knob, a press key or a touch screen. Referring to FIG. 1, the control device in this embodiment includes a switch 111 and two draw runners 112, the switch 111 is used for controlling the on-off state of a lamp load, and the two draw runners 112 are respectively used for adjusting the color temperature and the brightness of the lamp.

According to a control method of the high-power-density dimming power supply of embodiments of the present disclosure, the working frequency of the DC-DC power conversion circuit is set to be above 110 KHz, and the working frequency of the power factor correction circuit working in a continuous conduction mode is set to be above 75 KHz; or the working frequency of the power factor correction circuit working in a critical conduction mode near a zero crossing point is not limited, and the working frequency of the power factor correction circuit is set to be a value above 75 KHz when a voltage is above 1/2 of a wave peak voltage, so that the sizes of the magnetic elements in the DC-DC power conversion circuit and the power factor correction circuit are reduced, the power density of the dimming power supply is increased, and the output power of the product is improved to a value above 100 W under the condition of not increasing the product size. Therefore, the product may adapt to a high-power application scenario. It could be understood that the power factor correction circuit may judge whether the value is near a zero-crossing point or not by judging whether the voltage is lower than a preset threshold.

It needs to be noted that in descriptions of the present disclosure, the terms related to descriptions of orientations, for example, upper, lower, front, rear, left, right, etc. indicating the orientation or the positional relationship are all based on the orientation or the positional relationship shown in the accompanying drawings, are only for convenience of describing the present disclosure and simplifying the descriptions, are not intended to indicate or imply that the referenced devices or elements must have a particular orientation, be constructed and operated in a particular orientation, and therefore cannot be understood as a limitation of the present disclosure.

In the descriptions of the present disclosure, the meaning of “several” is one or more, the meaning of “plurality” is two and more than two, the terms such as “greater than”, “less than”, and “more than” shall be understood to exclude the number, and the terms such as “above”, “below”, and “within” shall be understood to include the number. The terms such as “first” or “second” are used only for the purpose of distinguishing the technical features, and should not be understood as indicating or implying the relative importance or implicitly specifying the quantity of the indicated technical features or implicitly specifying the precedence relationship of the indicated technical features.

In the descriptions of the present disclosure, unless otherwise expressly limited, the terms such as “dispose”, “install”, and “connect” should be understood in a broad sense, and those skilled in the art may reasonably determine the specific meaning of the above terms in the present disclosure in combination with the specific content of the technical solution.

The above implementations are only the exemplary implantations of the present disclosure and shall not be used to limit the protection scope of the present disclosure. Any inessential changes and substitutions made by those skilled in the art based on the present disclosure all fall within the protection scope claimed by the present disclosure.

What is claimed is:

1. A high-power-density dimming power supply, comprising: an outer housing (100) and a control circuit board (200), wherein the outer housing (100) comprises a control panel (110) and a rear housing (120), the control circuit board (200) is disposed in a space defined by the control panel (110) and the rear housing (120), a control device is disposed on the control panel (110), a control circuit is disposed on the control circuit board (200), an input terminal and an output terminal are disposed on the rear housing (120), the control circuit comprises a rectification filtering circuit, a power factor correction circuit, a direct current (DC)-DC power conversion circuit, an output control circuit and a main control circuit, an input end of the rectification filtering circuit is electrically connected with commercial power through the input terminal, an output end of the rectification filtering circuit is electrically connected with an input end of the power factor correction circuit, an output end of the power factor correction circuit is electrically connected with an input end of the DC-DC power conversion circuit, an output end of the DC-DC power conversion circuit is electrically connected with an input end of the output control circuit, the DC-DC power conversion circuit supplies electricity to the main control circuit, an output end of the output control circuit is electrically connected with a lamp load through the output terminal, the output control circuit is controlled by the main control circuit, the control device is electrically connected with the main control circuit, the DC-DC power conversion circuit uses a soft switching circuit architecture, a working frequency of the DC-DC power conversion circuit is set to be a value above 110 KHz, the control circuit board (200) comprises a main board (210) and a plurality of sub boards (220) vertically disposed on the main board (210), electronic components in the control circuit are distributed on the main board (210) and the sub boards (220), and in a case that the power factor correction circuit is in a continuous conduction mode, a working frequency of the power factor correction circuit is above 75 KHz; or in a case that the power factor correction circuit is in a critical conduction mode, the working frequency near a zero crossing point is not limited, and in a case that a voltage is above 1/2 of a wave peak voltage of alternating current, the working frequency of the power factor correction circuit is set to be a value above 75 KHz.

2. The high-power-density dimming power supply according to claim 1, wherein a plurality of slots or welding through holes are formed in the main board (210), one end of each of the sub boards (220) is provided with a conductive contact plate matched with the corresponding slot or a welding bonding pad matched with the corresponding welding through hole, and the sub boards (220) are electrically connected with the main board (210) through inserting the conductive contact plates into the slots or through welding.

3. The high-power-density dimming power supply according to claim 1, wherein a metal oxide semiconductor (MOS) transistor in the power factor correction circuit is a 3^{rd} generation semiconductor gallium nitride MOS transistor.

4. The high-power-density dimming power supply according to claim 1, wherein an MOS transistor in the DC-DC power conversion circuit is a 3^{rd} generation semiconductor gallium nitride MOS transistor.

5. The high-power-density dimming power supply according to claim 1, wherein each of a boost inductor in the power factor correction circuit and a coil of a transformer in the DC-DC power conversion circuit is formed by winding a stranded wire with a diameter of 0.1 mm or below.

6. The high-power-density dimming power supply according to claim 1, wherein the rectification filtering circuit is an active bridge rectification circuit.

7. The high-power-density dimming power supply according to claim 1, wherein the control device comprises a switch (111) and a dimming control device.

8. A control method of the high-power-density dimming power supply according to claim 1, comprising: controlling the working frequency of the DC-DC power conversion circuit to be above 110 KHz, and in a case that the power factor correction circuit works in a continuous conduction mode, controlling the working frequency of the power factor correction circuit to be above 75 KHz; and in a case that the power factor correction circuit works in a critical conduction mode, skipping limiting the lowest working frequency near a zero crossing point, and in a case that a voltage is above 1/2 of a wave peak voltage of alternating current, controlling the working frequency of the power factor correction circuit to be above 75 KHz.
